(19) United States
(12) Patent Application Publication
(10) Pub. No.: US 2026/0351220 A1
(43) Pub. Date: Nov. 5, 2026

(54) SYSTEMS AND METHODS FOR PROTECTIVELY ENCLOSING A MUSICAL INSTRUMENT

(71) Applicant: David Alan Templeman, Collinsville, IL (US)

(72) Inventor: David Alan Templeman, Collinsville, IL (US)

(21) Appl. No.: 19/662,580

(22) Filed: Apr. 29, 2026

Related U.S. Application Data
(60) Provisional application No. 63/797,231, filed on Apr. 30, 2025.

(51) Int. Cl. G10D 3/00

(52) U.S. Cl. CPC G10D 3/00

(57) ABSTRACT

A protective enclosure for a stringed musical instrument includes a shell formed from a transparent or translucent thermoplastic material. The shell includes a first shell portion and a second shell portion that collectively define an interior cavity having a shape corresponding to an external contour of a specific musical instrument. The shell is formed by heating the thermoplastic material to a pliable state and merging it with a guitar mold, creating an exact contoured shell. The shell is configured to remain on the musical instrument while the instrument is supported by a conventional guitar stand or wall mount. The shell portions may be connected by friction fit, hinged connection, zippered connection, or hook-and-loop fasteners. The enclosure provides multi-function capability for transport, wall display, stand display, and storage in a single lightweight product.

### CROSS-REFERENCE TO RELATED APPLICATIONS

This application claims priority to, and is a non-provisional application of U.S. Provisional Application 63/797,231 filed Apr. 30, 2025, which is hereby incorporated by reference in its entirety.

### FIELD OF THE INVENTION

The present invention relates generally to protective enclosures for musical instruments, and more particularly to a transparent shell configured to remain on a guitar or other stringed instrument while the instrument is displayed on a conventional stand or a wall mount, transported, and/or stored.

### BACKGROUND

Musicians and collectors of stringed musical instruments, particularly guitars, face ongoing challenges in protecting their instruments while also displaying them attractively. The prior art offers several solutions, each with significant limitations. For example, at least some musicians use traditional hard cases that are often fabricated with a thick, hard plastic and are lavishly padded on the inside. They are typically shaped as a generic guitar outline or rectangle and often such cases include a handle on the outside of the case that enables a user to carry the case despite its weight. Although such hard cases provide excellent protection during transport, the cases are opaque and do not permit visual display of the instrument once the lid to the case is shut on the body of the case. As a result, the instrument must be completely removed from the case for display or use, leaving it vulnerable to damage.

Other users may store their musical instruments, such as guitars, in a gig bag, which is a soft-sided fabric bag with no structural integrity, thus compromising protection. Within at least some known gig bags, at least a portion of the bag itself may be transparent. While lightweight and portable, gig bags offer minimal impact resistance and no display capability. Other known storage cases that include display capabilities include wall display cases and stand-convertible cases. At least some known wall display cases include rectangular box enclosures fabricated in a structurally rigid manner that forms a protective enclosure. Such display cases are intended to be hung to a wall and are not designed to be easily carried or transported from one location to another. In contrast, stand-convertible cases are designed to convert into instrument stands. However, these cases often require the instrument to be removed from the protective enclosure before being placed in the stand configuration, leaving the instrument unprotected during display.

None of the above-mentioned cases or bags can fit in commonly used guitar stands while the instrument remains encased. As such, musicians are often forced to choose protection and accessibility.

Accordingly, it is desirable to have a protective enclosure that combines the protective qualities of a hard case with the display capabilities of a transparent enclosure, while allowing the instrument to remain protected even when placed in a conventional guitar stand or mounted on a wall.

### BRIEF SUMMARY

In one aspect, a protective enclosure for a musical instrument is provided. The protective enclosure includes an upper shell member, a lower shell member, a peripheral interface region, and at least one interface region. The upper shell member and a lower shell member are each fabricated from a thermoplastic material and collectively define an interior cavity having a shape that substantially corresponds to an external contour of a specific musical instrument. The peripheral interface region is defined between the upper and lower shell members, and is configured to removably couple the upper and lower shell members together. The at least one interface region is formed within at least one of the upper and lower shell members to facilitate compatibility with a support structure such that the protective enclosure remains on the musical instrument while the musical instrument is supported by the support structure.

In another aspect, a method of protectively enclosing a musical instrument is provided. The method includes heating a thermoplastic material to a pliable state and forming the thermoplastic material against a mold corresponding to an external contour of a specific musical instrument to produce at least one shell member having an interior cavity that substantially corresponds to the external contour of the specific musical instrument. The at least one shell member is cooled to a rigid state, the musical instrument is positioned within the interior cavity, and an upper shell member and a lower shell member are coupled together along a peripheral interface region such that the musical instrument is encapsulated within the protective enclosure, wherein the protective enclosure remains on the musical instrument while the musical instrument is supported by a stand or wall mount.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an exemplary embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

Referring now to the drawings, wherein like reference numerals refer to like elements throughout the several views, FIG. 1-5 illustrate exemplary embodiments of a protective enclosure configured to receive and protect a musical instrument. There are shown in the drawings arrangements which are presently discussed, it being understood, however, that the present embodiments are not limited to the precise arrangements and are instrumentalities shown, wherein:

FIG. 1 is a perspective view of a first shell portion (i.e., a container shell) of an exemplary protective enclosure and illustrates a contoured interior cavity shaped to receive a guitar body and neck.

FIG. 2 is a cross-sectional perspective view of an assembled two-piece protective enclosure, showing the first and second shell portions of the enclosure joined together.

FIG. 3 is a perspective view of the protective enclosure with an enclosed guitar positioned in a conventional guitar stand, illustrating the stand compatibility feature of the invention.

FIG. 4 is a perspective view of a portion of the protective enclosure including an exemplary stand support member.

FIG. 5 is a perspective view of a mold block that may be used in the manufacturing process to create at least a portion of the protective enclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The present embodiments may relate to, inter alia, systems and methods for storing a musical instrument in a protective enclosure for transport, display, and/or storage, wherein the enclosure is formed from a first shell portion and a second shell portion that collectively define an interior cavity having a shape that substantially corresponds to an external contour of a specific musical instrument. The shell is configured to remain on the musical instrument while the musical instrument is supported by a stand or wall mount. In one embodiment, the manufacturing process produces an enclosure that includes a cavity that substantially corresponds to the external surface of a specific guitar model, creating a contoured shell that provides superior protection as compared to generic cavity designs because the instrument is held securely in a cavity in which minimal movement within the enclosure is permitted. The two shell portions may be connected by various attachment mechanisms including friction fit, hinged connection, zippered connection, magnetic connections, or hook-and-loop fasteners. In some embodiments, the shell may be clear or transparent, or translucent, may be colored, and/or may be formed with tinting of various colors to provide aesthetic effects and/or UV protection. In embodiments utilizing a friction fit with tight tolerances, the second shell portions (lids) may be interchangeable, allowing users to swap lids having different lighting configurations, colored options, and/or tinting options. In each embodiment, the protective enclosure can go from wall to travel to stage or performance area to storage, thus replacing the need for a travel case, a gig bag, and a wall display case, and providing an all-in-one product.

In one embodiment, the protective enclosure described herein is fabricated from any thermoplastic material that is heated to a pliable state and merged against or with a mold, such as a guitar-shaped mold, to create a contoured shell of the musical instrument, such as, but not limited to a guitar. The thermoforming process produces a shell that is contoured with a shape that substantially matches the external dimensions of a specific musical instrument, such as a specific guitar model, and thus provides form-fitting protection that is generally superior to generic cavity designs.

In the exemplary embodiments, a significant feature of the invention is that the shell may remain on the musical instrument while the musical instrument is supported by a stand or a wall mount, without obstructing view of the musical instrument inserted within the protective enclosure. This enables the instrument to be protected at all times—during transport, wall display, stand display, and storage, thus replacing the need for separate travel cases, gig bags, and wall display cases with a single multi-function product.

The first and second shell portions may be connected together via various attachment mechanisms, including, but not limited to, a friction fit, a magnetic connection, a hinged connection, a zippered connection, and/or a mechanical connection such as hook-and-loop fasteners. The transparent material may optionally be tinted, and/or the enclosure may include integrated backlighting to facilitate enhanced display aesthetics.

Although specific features of various embodiments may be shown in some drawings and not in others, this is for convenience only. In accordance with the principles of the systems and methods described herein, any feature of a drawing may be referenced or claimed in combination with any feature of any other drawing.

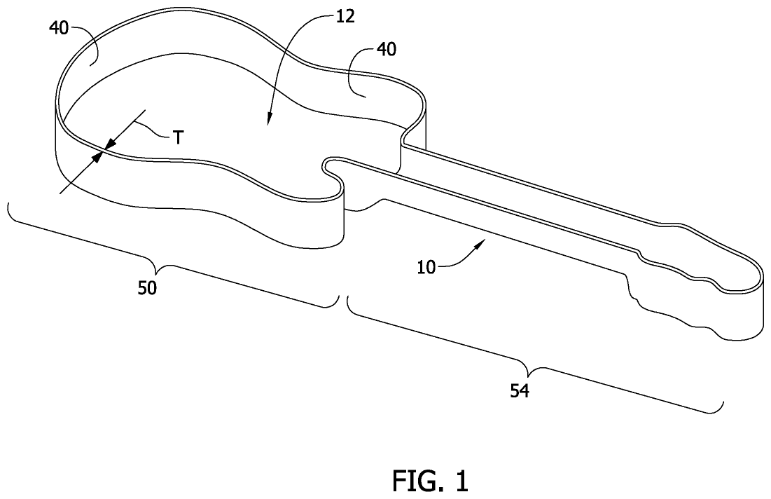

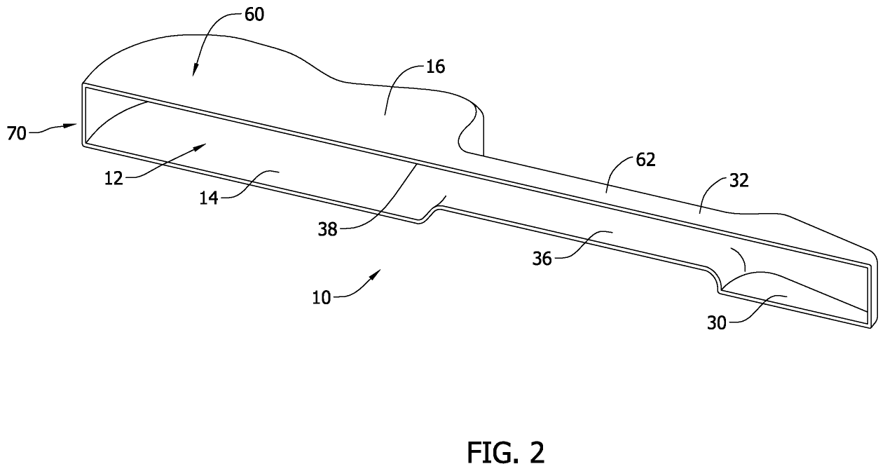

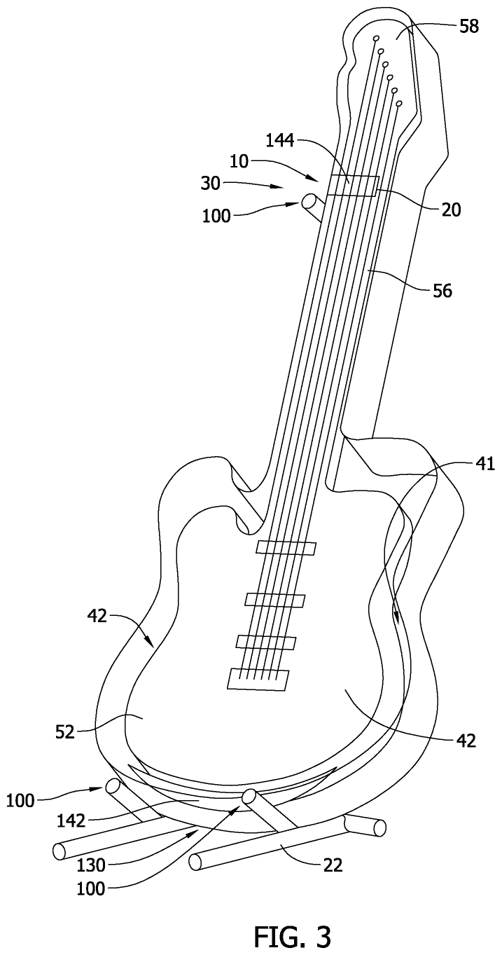

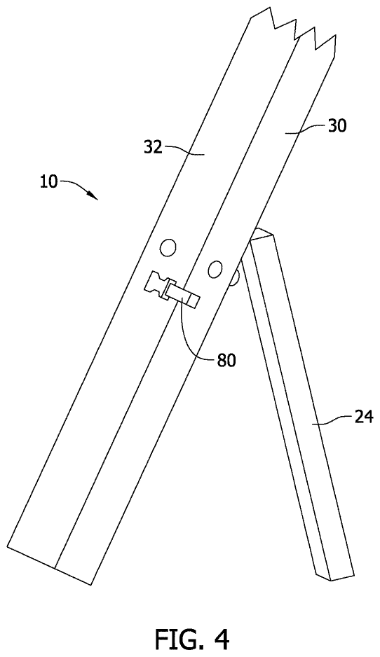

Referring generally to the drawings, FIG. 1 is a perspective view of a first shell portion (i.e., a container shell) of an exemplary protective enclosure 10 and illustrates a contoured interior cavity 12 shaped to receive a musical instrument (not shown in FIG. 1) therein. FIG. 2 is a cross-sectional perspective view of an assembled two-piece protective enclosure 10 and illustrates first and second shell portions 14 and 16, respectively, of the enclosure 10 coupled together. FIG. 3 is a perspective view of the protective enclosure 10 with an enclosed guitar 20 positioned in a conventional guitar stand 22, and FIG. 4 is a perspective view of a portion of the protective enclosure 10 supported by an exemplary stand support member 24.

In the exemplary embodiment, when assembled, the protective enclosure 10 the first or upper shell portion 14 and the second or lower shell portion 16 cooperate to define an enclosed cavity 12 when positioned in a closed configuration, as shown in FIG. 2. In the exemplary embodiment, the protective enclosure 10 is contoured with a shape that substantially matches the exterior shape of a musical instrument 20 to be contained within enclosure 10. More specifically, in the exemplary embodiment, the contoured cavity 12 defined within the protective enclosure 10 is sized and shaped to receive a guitar 20 therein. The cavity 12 is sized and shaped to facilitate providing enhanced protection to the musical instrument 20 contained therein as the instrument 20 is shipped, transported, displayed, and/or stored. The contoured cavity 12 is sized and shaped to enable the instrument 20 to be received and secured therein such that minimal movement of the instrument 20 is possible within the protective enclosure 10, as the instrument 20 is transported and/or stored, for example. More specifically, in the exemplary embodiment, the cavity 12 is sized and shaped such that a gap 41 defined between the walls 40 of the cavity 12 and the exterior surface 42 of the instrument contained therein is substantially uniform about the instrument 20, and is variably selected to facilitate reducing any possible movement of the instrument 20 after the instrument 20 is secured within the enclosure 10.

For the purposes of this application, the protective enclosure 10 in the exemplary embodiment is sized and shaped to receive a guitar 20 therein. However, the invention is not limited to only being used only with a guitar 20. Rather, the protective enclosure 10 may be adapted for use with other stringed musical instruments such as, but not limited to, banjos, violins, violas, cellos, mandolins, ukuleles, and/or bass guitars. Additionally, the invention may be adapted for use with non-stringed musical instruments such as, but not limited to, trumpets, saxophones, clarinets, and/or other instruments where protection during transport, display, and storage is desired. In each case, the mold and resulting shell would be configured to match the specific contours of the particular instrument, providing the same form-fitting protection and display capabilities described herein with respect to the guitar embodiment. In another exemplary embodiment, the protective enclosure 10 may be sized and shaped to receive more than one musical instrument therein, such as two trumpets or a pair of guitars, without departing from the invention.

In the exemplary embodiment, the protective enclosure 10 includes the lower shell member 14 (also referred to as the container portion or back portion) and the upper shell member 16 (also referred to as the cover portion or top portion). Moreover, in the exemplary embodiment, the upper and lower shell members 16 and 14, respectively, are fabricated in the same manner and each is fabricated from the same material. Alternatively, the upper and lower shell members 16 and 14, respectively, may be fabricated from different materials. In the exemplary embodiment, the shell portions 14 and 16 each have respective interior surfaces 36 and 38 that are contoured to substantially conform to the external surfaces 42 of the specific musical instrument 20 for which the protective enclosure 10 was created. Alternatively, in some embodiments, at least a portion of the interior surface 38 within the upper shell member 16 and/or at least a portion of the interior surface 36 within the lower shell member 14 may not substantially conform to the exterior surface 42 of the instrument 20 contained within the protective enclosure 10. For example, in some embodiments, at least a portion of the interior surface 38 within the upper shell member 16 may be substantially planar, rather than being contoured.

In the exemplary embodiment, the upper shell member 16 and the lower shell member 14 cooperate to define the interior cavity 12 when the protective enclosure 10 is in a closed configuration. For example, in the exemplary embodiment, the lower shell member 14 includes a body region 50 shaped to receive the body 52 of the guitar 20 and a neck region 54 shaped to receive the neck 56 and headstock 58 of the guitar 20 being received within the protective enclosure 10. Similarly, the upper shell member 16 includes corresponding body and neck regions 60 and 62, respectively, that are sized and shaped to receive corresponding portions of the instrument 20. The upper and lower shell members 16 and 14, respectively, mate together such that the instrument 20 is substantially encapsulated when fully inserted within the cavity 12. More specifically, when joined together, the upper and lower shell members 30 and 32 collectively define the contoured interior cavity 12 with a shape that substantially corresponds to the external contour of the specific musical instrument 20 being inserted within the protective enclosure 10.

In the exemplary embodiment, the upper shell member 16 and lower shell member 14 engage one another along a peripheral interface region 70, as best seen in FIG. 2. More specifically, in the exemplary embodiment, members 14 and 16 are sized to couple together without requiring the use of any tools and without the use of any adhesive, fasteners, or welding, for example, in an interference fit. In some alternative embodiments, the interference region 70 may be formed with and/or include a structural feature (not shown) coupled therein, to facilitate alignment, retention, and/or sealing between shell members 14 and 16 along the periphery of each member 14 and 16. For example, the interface region 70 may include, but is not limited to only including, a lip-and-groove connection, a recessed area, an overlapping flange, a stepped edge, a tongue-and-channel interface, or a compressible sealing member. In other embodiments, the interference region 70 may be formed with, but is not limited to only being formed with, stepped or tapered surfaces, logarithmic or roller-like profiles, and/or micro-roughness or texture to facilitate maintaining the shell portions 14 and 16 in a closed configuration during transport and storage.

In some embodiments, the interface region may include a friction-fit connection that is also configured to retain the shell portions 14 and 16 in engagement without the use of additional fastening hardware. The friction fit may be achieved through tight dimensional tolerances between the mating surfaces of the shell portions 14 and 16. In some embodiments, the surfaces within the interface region 70 may be manufactured to dimensional tolerances selected to maintain engagement between shell portions 14 and 16 during transport while permitting manual separation by a user.

In some embodiments, the protective enclosure 10 may include one or more mechanical fastening mechanisms 80 used to securely coupled shell members 14 and 16 together. For example, protective enclosure 10 may include, but is not limited to only including, a hinged connection, a latched connection, a snap connection, magnetic connectors, zippers, and/or hook-and-loop fasteners, for example. In other embodiments, shell members 14 and 16 are coupled together via a threaded connection, a snap-fit connection, a push-pull connection, a riveted connection, and/or an adhesive connection. In other embodiments, any suitable combination of fastening mechanisms 80 may be used to couple shell members 14 and 16 together without departing from the scope of the invention. In one embodiment, the shell members 14 and 16 are connected by a hinged connection along one edge, such that the enclosure 10 may be opened and closed like a clamshell.

In some embodiments, the protective enclosure 10 may include a sealing member positioned along the interface region 70 defined between the shell portions 14 and 16. In some embodiments, the sealing member is compressible. The sealing member may include, but is not limited to only including, an elastomeric gasket, foam strip, or flexible polymer seal configured to reduce an undesirable ingress of dust, moisture, and/or any other contaminants into the interior cavity 12.

In the exemplary embodiment, the shell portions 14 and 16 may be fabricated from thermoplastic or thermos-softening materials that become pliable when heated and rigid when cooled. For example, in some embodiments, shell portions 14 and/or 16 may be fabricated from, but is not limited to only being fabricated from, a polycarbonate material, an acrylic material, a polyethylene material, a polypropylene material, a polyvinyl chloride material, a polyethylene terephthalate material, a thermoplastic polyurethane material, and/or any combination of such materials or any other material that enables the protective enclosure to function as described herein.

The shell portions may be formed with any thickness T that is variably selected to provide sufficient structural rigidity to resist deformation during transport and handling. In some embodiments, the thickness T of the shell portions 14 and 16 may be substantially uniform. In some embodiments, the thickness T used in shell 14 may be different than the thickness T of material used in shell 16.

In some embodiments, the thickness T of material within enclosure 10 may vary across different regions of the enclosure 10 to provide additional strength in load-bearing areas while reducing an overall weight of the enclosure 10. For example, the shell portions 14 and 16 may include reinforced areas adjacent to the body portion 52 of the instrument 20, reinforced regions adjacent to the neck portion 56, and/or reinforced regions adjacent to the interface region 70. These reinforced regions may be formed by increasing wall thickness, incorporating ribs or structural features, and/or using higher-strength materials, for example.

The shell portions 14 and/or 16 may include structural regions configured to distribute loads transmitted through a support structure or during transport. These regions may include reinforced sections, ribs, or increased wall thickness positioned adjacent high-stress areas of the enclosure.

In some embodiments, the shell portions 14 and/or 16 may include surface treatments or coatings configured to enhance durability or appearance. Such treatments may include, but are not limited to only including, scratch-resistant coatings, UV-resistant coatings, anti-fog coatings, anti-static coatings, decorative finishes, and/or any combination of these materials and/or any other known material that enables the protective enclosure to function as described herein.

In the exemplary embodiment, the protective enclosure 10 is formed from a material that is transparent or translucent to permit visual display of the instrument 20 contained within the enclosure 10. More specifically, in the preferred embodiment, the protective enclosure is fabricated from a thermoplastic material that is clear or transparent, thus allowing the enclosed instrument 20 to be fully visible while the instrument is encapsulated within the enclosure 10. Alternatively, the material may be translucent, providing visibility while diffusing light. The clear material may optionally be tinted with various colors to provide aesthetic effects and/or to facilitate ultraviolet (UV) protection for the instrument 20. The transparency of the protective enclosure 10 enables the guitar 20 to be displayed while stored or transported while remaining fully protected, thus addressing a significant limitation of conventional opaque hard cases. The transparent or translucent material enables visual inspection and display of the instrument without removal from the enclosure.

The tinting may be applied during the manufacturing process or after the formation of the shell portions 14 and 16. In some embodiments, the tinting may be removable or interchangeable. For example, a user may select from multiple interchangeable shell portions 14 and/or 16 having different tint colors or optical characteristics.

In some embodiments, the protective enclosure 10 may include an illumination system (not shown) configured to enhance visual display of the instrument contained within the enclosure 10. The illumination system may include one or more light sources positioned within or adjacent to the shell portions 14 and 16. For example, in one embodiment, the illumination system is within the cavity and circumscribes the lowest surface defining the cavity 12 to provide a back light to the instrument contained within the protective enclosure 10. Suitable light sources may include, but are not limited to only including, light-emitting diodes (LEDs), fiber-optic lighting elements, electroluminescent panels, incandescent bulbs, and/or a combination of such lighting and/or any other known lighting that enables the protective enclosure 10 to function as described herein.

The light sources may be positioned along the interior perimeter of either shell 14 and/or 16, the rear surface of either shell 14 and/or 16, only within the body portion 50 or 60 of either shell 14 and/or 16, or the neck region 54 or 62 of either shell 14 and/or 16, and/or at any location that enables the illumination system to function as described herein. In some embodiments, the illumination system may include a diffuser configured to distribute light substantially evenly across the interior cavity 12. The backlighting enhances the visual display of the instrument 20, particularly in low-light environments.

The illumination system may be powered by a rechargeable battery, a replaceable battery, a wired electrical connection, or a USB connection. A power source may be integrated into the enclosure 10 or provided as an external connection. In some embodiments, the illumination system may include user controls that enable selective adjustments to the brightness, color, or lighting patterns of the illumination system.

In the exemplary embodiment, the protective enclosure 10 may include one or more interface support regions 100 configured to facilitate compatibility with a support structure, such as a conventional guitar stand 22 or a wall-mounted instrument support. Each interface region 100 may include one or more recesses, openings, channels, or clearance regions formed within the shell portions 14 and/or 16. These interface regions may be positioned to generally align with support elements of the stand 22, such as support arms, neck supports, base supports, and/or strap-button engagement members, thereby allowing the instrument 20 to remain enclosed within the protective enclosure 10 while being supported in a stable position.

In some embodiments, each interface region 100 may be sized and shaped to receive a portion of the stand 22 such that the stand engages the instrument 20 directly while the protective enclosure 10 remains attached to the instrument. In other embodiments, the stand 22 may engage the protective enclosure 10 itself. In still other embodiments, each interface region 100 may include a reinforced portion of the shell 16 configured to bear load transmitted through the stand during support of the instrument 20. The clearance regions may correspond to the lower portion of the guitar body where a conventional stand typically engages the instrument. The stand support member 24 engages the protective enclosure 10 within the clearance regions, providing stable support while the guitar 20 remains fully enclosed.

In the exemplary embodiment, the protective enclosure 10 includes a kick stand 110 that may be selective folded outward from shell 30 to enable the protective enclosure 10 to support itself as a musical instrument 20 is displayed.

When used with an optional cup and clip accessory 130, the lower shell member 32 of the two-piece enclosure 10 secures the guitar 20 in its encapsulated case while positioned in the guitar stand 22. The cup portion 142 of the accessory 130 receives a support arm of the stand, while the clip 144 secures the enclosure 10 to the stand, providing stability and preventing the encased instrument from falling. More generally, in the exemplary embodiment, the clip 144 couples to an upper end of the instrument 20, such as the guitar neck portion 56, and the cup portion 142 is a hollow member that is sized to enable the lower portion of the protective enclosure therein on a stand 22. This stand compatibility feature distinguishes the present invention from prior art cases, which require the instrument 20 to be removed from the case before being placed in a stand.

In the exemplary embodiment, the protective enclosure 10 may also be configured for compatibility with wall-mounted instrument supports. The upper shell member 16 or lower shell member 14 may include mounting features such as keyhole slots, brackets, or other attachment points that facilitate securing the protective enclosure 10 to a wall. In this configuration, the enclosed instrument 20 is displayed vertically on the wall while remaining fully protected within the transparent enclosure 10. Alternatively, in this configuration, the enclosed instrument 20 may be displayed at any angle or arrangement on a wall while remaining fully protected within the enclosure 10.

The enclosure 10 may also include a clearance region positioned adjacent the headstock portion of the instrument 20 to allow engagement with a wall-mounted support member. The clearance region may be formed as an opening, recess, slot, or channel extending through or partially through one or both shell portions 14 and 16. This configuration enables the instrument 20 to remain enclosed while mounted to a wall support without requiring removal of the protective enclosure 10.

The wall mount configuration provides a display option for collectors and musicians who wish to showcase their instruments 20 while maintaining protection from dust, humidity, and accidental contact.

The protective enclosure 10 can go from wall to travel to storage, replacing the need for a travel case, a gig bag, and a wall display case, all in one product. This multi-function capability provides significant advantages over prior art solutions that require separate products for each use case. For example, conventional hard cases, while providing excellent protection during transport, are opaque and do not permit visual display of the instrument, and the instrument must be completely removed from the case for display or use. Gig bags, while lightweight and portable, offer minimal impact resistance and no display capability. Wall display cases are not portable and do not provide adequate protection during transport. Some prior art cases are designed to convert into instrument stands; however, these require the instrument to be removed from the protective enclosure before being placed in the stand configuration, leaving the instrument unprotected during display.

The lightweight construction of the thermoformed shell provides a safe, protective travel shell at a lighter weight compared to conventional hard cases. At the same time, the rigid thermoplastic material provides a hard shell contoured protective carrier that offers superior protection compared to soft-sided gig bags. The transparent nature of the enclosure 10 further enables the instrument to be displayed while protected, a capability not available with conventional opaque cases. None of the above-mentioned prior art cases or bags can fit in commonly used guitar stands while the instrument remains encased. The protective enclosure 10 of the present invention addresses this limitation by enabling the instrument 20 to remain within the enclosure 10 while supported by a conventional guitar stand 22 or wall mount, thereby providing continuous protection across all modes of use.

In some embodiments, the protective enclosure 10 may include one or more ventilation openings or clearance regions formed within the shell portions 14 and/or 16. The ventilation openings may be positioned to correspond to strap buttons, output jacks, tuning pegs, or other functional features of the instrument 20. These openings allow for air circulation within the interior cavity 12 to prevent moisture buildup and condensation, which may otherwise damage the instrument's finish or structural integrity. The ventilation openings may also provide access to instrument controls, such as volume knobs, pickup selectors, or output jacks, without requiring removal of the enclosure 10.

In some embodiments, the ventilation openings are positioned and sized to minimize visibility while maximizing airflow, thereby maintaining the aesthetic appearance of the displayed instrument. The openings may be formed as slots, perforations, channels, or mesh-covered apertures. In some embodiments, the ventilation openings may include removable plugs or covers that may be inserted when the enclosure 10 is used for transport, thereby providing a substantially sealed enclosure during transit while permitting ventilation during display or storage.

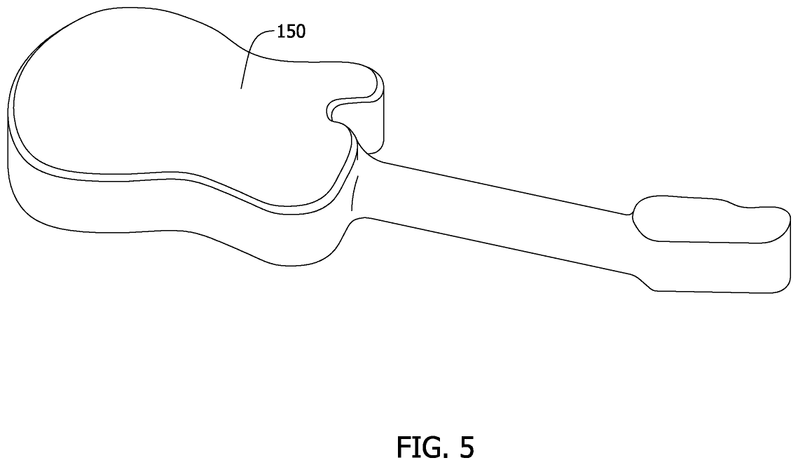

FIG. 5 is a perspective view of a mold block 150 that may be used in the manufacturing process to create at least a portion of the protective enclosure 10. In the exemplary embodiment, the shell portions 14 and 16 may be manufactured using a thermoforming process in which a sheet of thermoplastic material is heated to a pliable state and positioned against a mold 150 corresponding to the external contour of the instrument. The mold 150 may be created using direct measurement of the instrument, three-dimensional scanning, digital modeling, or casting of a replica. After positioning the heated material against the mold, a vacuum or pressure may be applied to draw the material into conformity with the mold surface. The material may then be cooled to produce a rigid shell.

During the fabrication process, in the exemplary embodiment, the thermoplastic or thermosoftening plastic, which is any plastic polymer, becomes pliable when heated and solidifies and hardens upon cooling. Suitable thermoplastic materials include, but are not limited to, polycarbonate, acrylic (PMMA), PETG, ABS, colored materials, and/or other clear or translucent polymers having sufficient rigidity and impact resistance for protective applications. In the exemplary embodiment, the thermoforming process utilizes a mold block 150 having a cavity defined therein that substantially corresponds to the external surface of a specific guitar model. In the pliable state, the heated thermoplastic material is merged with the mold block 150, thus creating an exact contoured shell of the guitar 20 or other stringed instrument. This may be accomplished through vacuum forming, pressure forming, or other thermoforming techniques known in the art. The resulting shell portions have interior surfaces that conform precisely to the external dimensions of the specific guitar model for which the mold was created. This exact contour replication provides superior protection compared to generic cavity designs, as the instrument is held securely with minimal movement within the enclosure.

In some embodiments, the shell portions 14 and/or 16 may be manufactured using alternative processes, including, but not limited to only including, injection molding, blow molding, compression molding, or rotational molding, which may produce shell structures functionally similar to those illustrated in FIG. 1 through FIG. 4.

In an alternative embodiment, either shell 16 and/or 14 may be tinted with various colors. Tinting provides aesthetic effects, allowing the enclosure to complement the instrument's finish or the owner's personal style. Additionally, tinted material may provide UV protection for the instrument 20, reducing potential fading or degradation of the instrument's finish from prolonged light exposure. The tinting may range from light shading that still permits clear visibility of the instrument to darker tints that provide a degree of privacy while still permitting the general form of the instrument to be visible.

In another alternative embodiment, either shell 14 and/or 16 may be fabricated using additive manufacturing processes, commonly known as 3D printing. Suitable 3D printing techniques include fused deposition modeling (FDM), stereolithography (SLA), or selective laser sintering (SLS). 3D printing allows for highly customized contours and complex geometries that may be difficult to achieve with traditional thermoforming. This process is particularly advantageous for creating shells for instruments with unusual shapes or for producing small quantities of custom-fitted enclosures. The 3D printed shell may be formed from transparent or translucent polymers such as PETG, polycarbonate, or clear resins.

In yet another alternative embodiment, either shell 14 and/or 16 may be fabricated using injection molding. Injection molding is well-suited for high-volume production, wherein molds are created to match specific instrument contours. Once the mold is created, injection molding allows for rapid, repeatable production of shells with consistent quality and precise dimensional tolerances. The injection-molded shell may be formed from transparent or translucent thermoplastic materials such as polycarbonate, acrylic (PMMA), or ABS. This manufacturing method is particularly advantageous when producing large quantities of shells for popular guitar models.

In embodiments wherein the second shell portion (lid) 16 is connected to the first shell portion 14 by a friction fit with tight tolerances, the lids 16 may be interchangeable. For example, a user may have multiple second shell portions 16 for a single first shell portion 14, wherein each second shell portion 16 provides different features. Some lids 16 may include alternative lighting configurations, such as different LED colors or lighting patterns. Other lids 16 may be multi-tinted, allowing the user to change the aesthetic appearance of the enclosure by swapping lids 16. This interchangeability provides versatility and customization options for the user without requiring multiple complete enclosures.

In some embodiments, the protective enclosure 10 may be configured as a partial enclosure that covers only a portion of the instrument 20, as may be implemented in alternative shell configurations. For example, the enclosure 10 may include a front shell portion, a rear shell portion, a body-only enclosure, or a neck-only enclosure. In other embodiments, the protective enclosure 10 may be configured to receive/display/store/transport multiple instruments simultaneously. For example, the enclosure may include separate interior cavities configured to receive two guitars, two violins, or multiple wind instruments.

Exemplary technical effects of the protective enclosure described herein include, for example: (a) protectively enclosing a musical instrument within a form-fitting shell without obstructing visual display of the instrument; (b) removably enclosing a musical instrument within a two-piece shell that remains on the instrument while the instrument is supported by a stand or wall mount; (c) providing a protective enclosure system that replaces the need for separate travel cases, gig bags, and wall display cases with a single multi-function product; and (d) providing a protective enclosure that can be sized and shaped to conform to the specific external contour of any musical instrument.

Exemplary embodiments of a protective enclosure system and related components are described above in detail. The system is not limited to the specific embodiments described herein, but rather, components of systems and/or steps of the methods may be utilized independently and separately from other components and/or steps described herein. For example, the configuration of components described herein may also be used in combination with other processes, and/or applications, and is not limited to practice with the systems and related methods as described herein. Rather, the exemplary embodiment can be implemented and utilized in connection with many applications where protectively enclosing a musical instrument is desired.

Although specific features of various embodiments of the present disclosure may be shown in some drawings and not in others, this is for convenience only. In accordance with the principles of the present disclosure, any feature of a drawing may be referenced and/or claimed in combination with any feature of any other drawing.

This written description uses examples to disclose the embodiments of the present disclosure, including the best mode, and also to enable any person skilled in the art to practice the disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A protective enclosure for a musical instrument, the protective enclosure comprising:
an upper shell member and a lower shell member, each fabricated from a thermoplastic material, the upper and lower shell members collectively defining an interior cavity having a shape that substantially corresponds to an external contour of a specific musical instrument;
a peripheral interface region defined between the upper shell member and the lower shell member, the peripheral interface region configured to removably couple the upper and lower shell members together; and
at least one interface region formed within at least one of the upper and lower shell members, the at least one interface region configured to facilitate compatibility with a support structure such that the protective enclosure remains on the musical instrument while the musical instrument is supported by the support structure.

2. The protective enclosure of claim 1, wherein the thermoplastic material is transparent.

3. The protective enclosure of claim 1, wherein the thermoplastic material is translucent.

4. The protective enclosure of claim 1, wherein the thermoplastic material is tinted.

5. The protective enclosure of claim 1, wherein the peripheral interface region comprises a friction fit interface, wherein peripheral edges of the upper and lower shell members are dimensioned to engage one another with sufficient friction to maintain a closed configuration.

6. The protective enclosure of claim 1, wherein the peripheral interface region comprises a hinged connection along one edge of the upper and lower shell members.

7. The protective enclosure of claim 1, wherein the peripheral interface region comprises one of a zippered connection and a magnetic connection extending around at least a portion of the peripheral edges of the upper and lower shell members.

8. The protective enclosure of claim 1, wherein the peripheral interface region comprises hook-and-loop fasteners positioned along peripheral edges of the upper and lower shell members.

9. The protective enclosure of claim 1, wherein the at least one interface region comprises one or more clearance regions formed within at least one of the upper and lower shell members, the clearance regions positioned to align with support elements of a guitar stand.

10. The protective enclosure of claim 1, further comprising an illumination system configured to enhance visual display of the musical instrument, the illumination system including one or more light sources positioned within or adjacent at least one of the upper and lower shell members.

11. The protective enclosure of claim 10, wherein the illumination system is powered by at least one of a rechargeable battery, a replaceable battery, a wired electrical connection, or a USB connection.

12. The protective enclosure of claim 1, further comprising mounting features formed on at least one of the upper and lower shell members, the mounting features configured to secure the protective enclosure to a wall.

13. The protective enclosure of claim 1, further comprising one or more ventilation openings formed within at least one of the upper and lower shell members, the ventilation openings configured to permit air circulation within the interior cavity.

14. The protective enclosure of claim 5, wherein the upper shell member is interchangeable with a plurality of alternative upper shell members, each alternative upper shell member providing different features.

15. The protective enclosure of claim 1, wherein the interior cavity is formed by thermoforming the thermoplastic material against a mold corresponding to the external surface of the specific musical instrument.

16. The protective enclosure of claim 1, wherein the upper shell member includes a body region shaped to receive a body of the musical instrument and a neck region shaped to receive a neck and headstock of the musical instrument.

17. The protective enclosure of claim 1, further comprising a cup and clip accessory configured to secure the protective enclosure to a guitar stand.

18. The protective enclosure of claim 1, wherein a gap defined between walls of the interior cavity and an exterior surface of the musical instrument is substantially uniform about the musical instrument.

19. A method of protectively enclosing a musical instrument comprising:
heating a thermoplastic material to a pliable state;
forming the thermoplastic material against a mold corresponding to an external contour of a specific musical instrument to produce at least one shell member having an interior cavity that substantially corresponds to the external contour of the specific musical instrument;
cooling the at least one shell member to a rigid state;
positioning the musical instrument within the interior cavity; and
coupling an upper shell member and a lower shell member together along a peripheral interface region to encapsulate the musical instrument within the protective enclosure, wherein the protective enclosure is configured to remain on the musical instrument while the musical instrument is supported by a stand or wall mount.

20. The method of claim 19, further comprising forming at least one interface region within at least one of the upper and lower shell members, the at least one interface region configured to facilitate compatibility with a support structure.
